(19) United States
(12) Patent Application Publication
(10) Pub. No.: US 2021/0379737 A1
(43) Pub. Date: Dec. 9, 2021

(54) Multi-Functional Water Meter Key

(71) Applicant: Winford Davis, JR., Vanndale, AR (US)

(72) Inventor: Winford Davis, JR., Vanndale, AR (US)

(21) Appl. No.: 17/160,218

(22) Filed: Jan. 27, 2021

Related U.S. Application Data
(60) Provisional application No. 63/034,702, filed on Jun. 4, 2020.

(51) Int. Cl. B25B 13/48; B25B 23/00; B25B 13/06

(52) U.S. Cl. CPC B25B 13/48; B25B 23/16; B25B 13/065; B25B 23/0035

(57) ABSTRACT

The multifunctional water meter key is an apparatus that includes multiple water meter keys that may be operated on a variety of water meter valves and plugs, mutually exclusively. To accomplish this, a main rod provides enough length and reachability for the device, and a first water meter key is mounted on to a terminal end of the rod. Further, a second water meter key that may be operable on multiple plugs/valves, is mounted in a slidable fashion across the rod and temporarily fastened at various positions across the rod. A flexible fastening mechanism enable fastening of the second key in such a way that the position of the second key does not interfere with the operation of the first and/or second water meter key. Additionally, a handle provides leverage for the apparatus to operate on various water meter valves.

The current application claims a priority to the U.S. Provisional Patent application Ser. No. 63/034,702 filed on Jun. 4, 2020.

### FIELD OF THE INVENTION

The present invention relates generally to a water meter key. More specifically, the present invention is a multi-functional water meter key which may be used for commercial and residential purposes.

### BACKGROUND OF THE INVENTION

Water metering refers to the process of measuring water use, typically within a public water supply system. A water meter key is a tool that consists of a handle with two prongs at the end, or a slot that fits over the fin or plug on the meter valve. Once you get the tool in place, you can rotate it for turning on or turning off the flow of water through a particular water supply system. There are a variety of water meter keys available at the market, that are catered to opening and closing of residential water meter keys, commercial water meter keys, sewer cleanout plugs etc. However, an apparatus that includes multiple water meter keys within itself and which may be used mutually exclusively on different valves and plugs, is a rare find in the current market.

It is an objective of the present invention to provide users with a single device that comprises multiple water meter keys, and which allows the device to be operated on a variety of water meter valves and plugs mutually exclusively. According to the present invention, a main rod that provides enough length and reachability for the device forms the central structure, and to this rod a first water meter key is mounted terminally. Further, a second water meter key that may be used on multiple plugs and valves is mounted in a slidable fashion across the rod. Furthermore, a fastening mechanism of the present invention enable fastening of the second water meter key in such a way that the position of the second key does not interfere with the operation of the first water meter key. Additionally, a handle provides leverage for the device to turn the various valves ON and OFF. Thus, the present invention is a multifunctional water meter key that is user-friendly and cost efficient.

### BRIEF DESCRIPTION OF THE DRAWINGS

FIG. 1 is a top-front-left perspective view of the present invention, wherein the second key is in a stored configuration.

FIG. 2 is a detailed view of section 2 of FIG. 1.

FIG. 3 is a bottom-rear-left perspective view of the present invention.

FIG. 4. is front elevational view of the present invention.

FIG. 5 is a top plan view of the present invention.

FIG. 6 is a left elevational view of the present invention.

FIG. 7 is a bottom-rear-right perspective view of the present invention, wherein the second key is in a deployed configuration.

FIG. 8 is a detailed view of the section 8 in FIG. 7.

FIG. 9 is a top-front-left perspective view of the present invention, wherein the second key is in a deployed configuration.

FIG. 10 is a rear elevational view of the present invention.

FIG. 11 is a bottom plan view of the present invention.

### DETAIL DESCRIPTIONS OF THE INVENTION

All illustrations of the drawings are for the purpose of describing selected versions of the present invention and are not intended to limit the scope of the present invention.

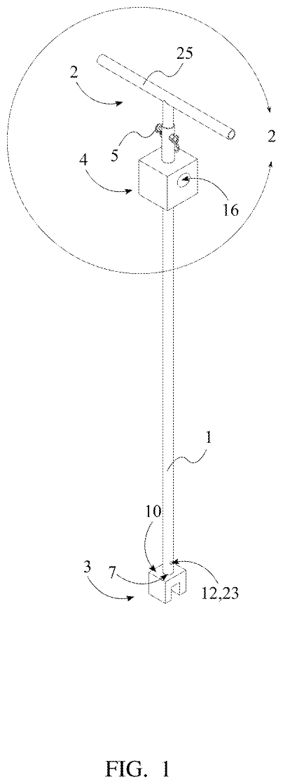

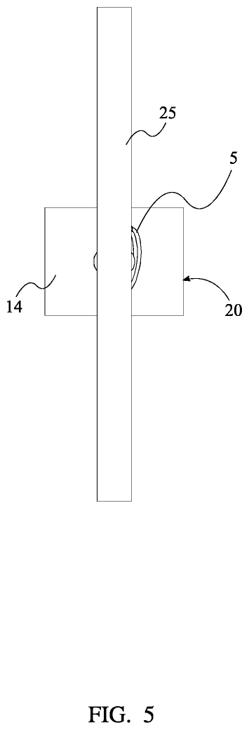

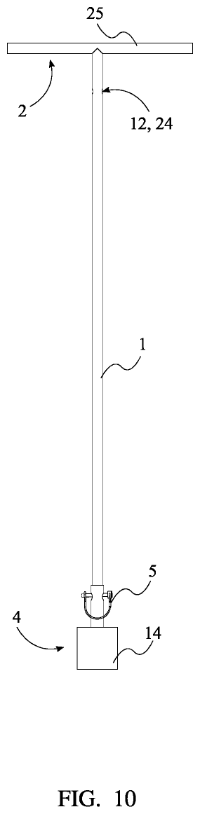

In reference to FIG. 1 through FIG. 11, the present invention is a multi-functional water meter key. It is an objective of the present invention to provide users with a single device that comprises multiple water meter keys, and which allows the device to be operated on a variety of water meter valves and plugs, mutually exclusively. According to the present invention, a main rod that provides enough length and reachability for the device forms the central structure, and to this rod a first water meter key is mounted terminally. Further, a second water meter key that may be used on multiple plugs and valves is mounted in a slidable fashion across the rod. Furthermore, a fastening mechanism of the present invention enable fastening of the second water meter key in such a way that the position of the second key does not interfere with the operation of the first water meter key. Additionally, a handle provides leverage for the device to turn the various valves ON and OFF. Thus, the present invention is a multifunctional water meter key that is user-friendly and cost efficient.

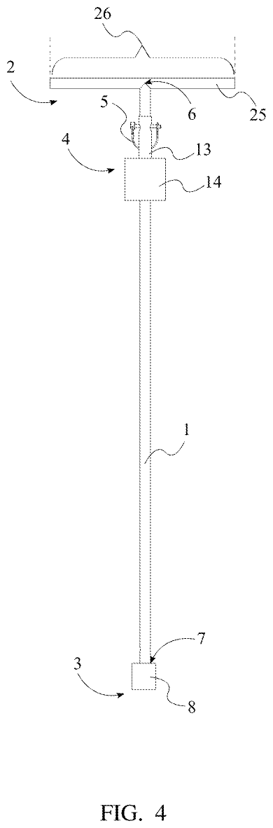

The following description is in reference to FIG. 1 through FIG. 11. According to a preferred embodiment, the present invention comprises a rod 1, a handle 2, a first key 3, a second key 4, and a fastener 5. As seen in FIG. 1, and FIG. 4, the rod 1 comprises a first end 6 and a second end 7, and the first end 6 is positioned opposite to the second end 7 across the rod 1. Preferably, the rod 1 is a schedule 40 bare metal tubing pipe, that is approximately 60 inches long, such that the rod 1 may provide reachability to shallow and deeper water meters. However, the rod 1 may comprise any other size, shape, material and dimensions, as long as the objectives of the present invention are fulfilled. As seen in FIG. 1 through FIG. 7 and FIG. 9 through FIG. 11, the handle 2 is terminally mounted onto the first end 6. Preferably, the handle 2 is a schedule 40 bare metal, round tubing pipe that is approximately 2.75 inches in length, and that is welded onto the upper end of the rod 1. The handle 2 is intended to give leverage to turn the water meter keys of the present invention ON and OFF. Further, the handle 2 also gives leverage to install and take off PVC caps of multiple dimensions. However, the handle 2 may comprise any other shape, material, dimensions, components and arrangement of components, as long as the objectives of the present invention are not altered.

It is an objective of the present invention to include multiple water meter keys within the same device. To that end the first key 3 is terminally mounted onto the second end 7, and the second key 4 is slidably coupled along the rod 1. According to the preferred embodiment, the first key 3 is a residential meter key head, and the second key 4 is a commercial meter key head. However, any kind of and/or combination of keys may be utilized, as long as the objectives of the present invention are not hindered.

Further, in order to securely hold the slidable second key 4 at different positions across the rod 1 and prevent interference of either keys during their operation, the fastener 5 is removably engaged between the rod 1 and the second key 4. Preferably, the fastener 5 is a double wire snap safety pin, that engages through holes in the rod 1. However, the fastener 5 may comprise any other size, brand, type, components, and arrangement of components that are known to one of ordinary skill in the art, as long as the intents of the present invention are not altered. Examples of such fasteners include, but are not limited to snap clips, magnetic fasteners, hook and loop fasteners, etc.

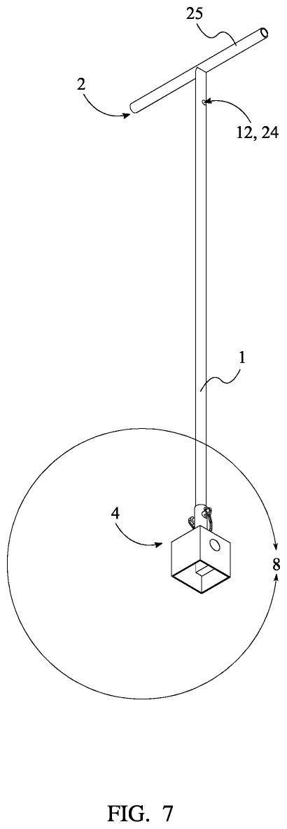

According to the preferred embodiment of the present invention, the second key 4 is slidable across the rod 1, and the second key 4 may be secured in multiple positions on the rod 1 with the help of the fastener 5. Accordingly, wherein the second key 4 is in a deployed configuration, the second key 4 is positioned adjacent the second end 7. As seen in FIG. 7 through FIG. 11, the second key 4 is fastened to the rod 1 by the fastener 5 and the first key 3 is encompassed by the second key 4, when the second key 4 is in the deployed configuration. In other words, in the deployed configuration or when the second key 4 in the operating mode, the first key 3 is covered by the second key 4 and the first key 3 would be in a dormant mode. Similarly, as seen in FIG. 1 through FIG. 6, wherein the second key 4 is in a stored configuration, the second key 4 is positioned adjacent the first end 6, and the second key 4 is fastened to the rod 1 by the fastener 5. In other words, when the second key 4 is in the stored configuration, the first key 3 is in the operating mode and the second key 4 is in a position that does not interfere with the first key 3.

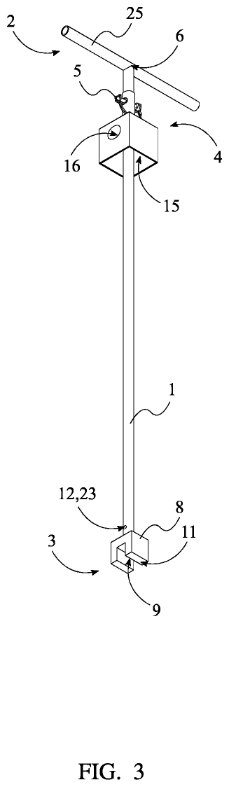

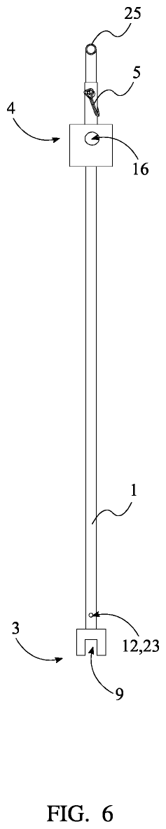

As seen in FIG. 1, FIG. 3, FIG. 4 and FIG. 6, the first key 3 comprises a cuboid body 8, a slot 9, a first surface 10 and a second surface 11. Preferably, the slot 9 laterally traverses through the cuboid body 8, and the slot 9 is positioned centrally along the cuboid body 8. This is so that the slot 9 may be engaged into a fin or protruding portion of a water meter valve. Further, the first surface 10 is positioned opposite to the second surface 11 across the cuboid body 8 and the first surface 10 is attached to the second end 7 of the rod 1. Furthermore, as seen in FIG. 3, the slot 9 extends from the second surface 11 towards the first surface 10 and the slot 9 comprises a rectangular cross section.

Preferably, the first key 3 may be inserted into a 2/4 inches female adapter PVC cap, which when turned clockwise tightens the PVC cap onto the female adapter, and when turned counter clockwise, the PVC cap gets untightened and may be removed from the female adapter. Similarly, when the slot 9 of the first key 3 is inserted over a residential water meter valve head and turned clockwise, it will turn the water ON the water meter, and when turned counter clockwise, the first key 3 will turn the water OFF at the water meter.

In order to secure the second key 4 to the rod 1 with the fastener 5, the present invention comprises a first plurality of fastening holes 12, wherein the first plurality of fastening holes 12 is distributed along the rod 1. Preferably, the first plurality of fastening holes 12 is circular in shape and traverse laterally through the rod 1. However, the first plurality of fastening holes 12 may comprise any other shape, size and location, as long as the intents of the present invention are not altered.

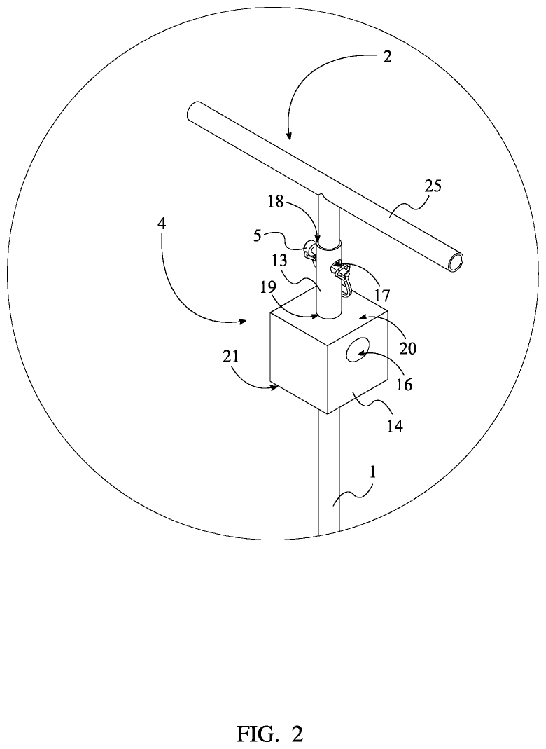

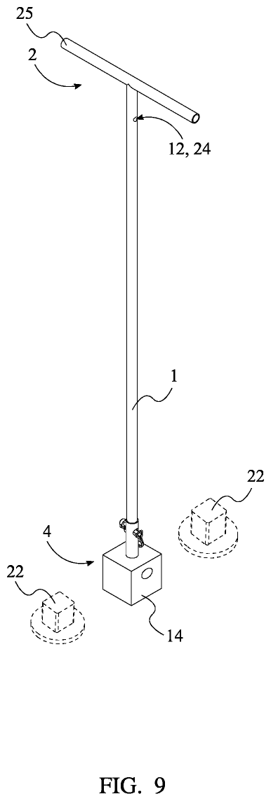

According to the preferred embodiment of the present invention, the second key 4 is a commercial water meter key. Accordingly, the second key 4 comprises a sleeve 13, a receptacle 14, an inner compartment 15, a plurality of mud holes 16, and a second plurality of fastener holes 17. Preferably, the sleeve 13 comprises a third end 18 and a fourth end 19, wherein the third end 18 is positioned opposite to the fourth end 19 across the sleeve 13. As seen in FIG. 2, the third end 18 is positioned facing the handle 2 and the fourth end 19 is positioned facing the second end 7 of the rod 1. Further, the receptacle 14 comprises a fifth end 20 and a sixth end 21, wherein the fifth end 20 is positioned opposite to the sixth end 21 across the sleeve 13. In other words, the fifth end 20 and the sixth end 21 define two opposing edges of the receptacle 14. Furthermore, the fifth end 20 of the receptacle 14 is attached to the fourth end 19 of the sleeve 13, and the inner compartment 15 traverses into the receptacle 14 from the sixth end 21 towards the fifth end 20. According to the preferred embodiment, a transversal cross section of the inner compartment 15 enables the second key 4 to be operably coupled to a plurality of plugs 22. In other words, dimensions of the inner compartment 15 enable the second key 4 to be operated on PVC caps of multiple sizes. For example, as seen in FIG. 9, the second key 4 may be used to unfasten/tighten a plurality of plugs 22 such as a 3″ sewer cleanout plug, and a 4″ sewer cleanout plug. Preferably, the second key 4 is a commercial water meter key head made of a 2.5/2.5 inches square metal receptacle 14. The second key 4 can be inserted over 2/4 male adapter, which when turned clockwise will tighten the PVC cap onto the male adapter. Further, when turned counter-clockwise, the second key 4 may take off the PVC cap from the male adapter. Furthermore, the second water key 4 may be inserted over a commercial water meter valve head and turned clockwise to turn the water ON and turned counter-clockwise to turn the water OFF.

As may be clearly observed in FIG. 2, the sleeve 13 is wrapped around the rod 1, thereby providing structural stability to the second key 4. Furthermore, the plurality of mud holes 16 laterally traverses through the receptacle 14. The plurality of mud holes 16 provides a drainage path for mud, water, slush, dirt etc. through the receptacle 14, thereby preventing any interruption to the smooth functioning of the second key 4 by such elements. Additionally, the second plurality of fastener holes 17 laterally traverses through the sleeve 13, such that the second plurality of fastener holes 17 enables the fastener 5 to engage through second plurality of fastener holes 17 and the first plurality of fastener holes 12 for securing the second key 4 to the rod 1.

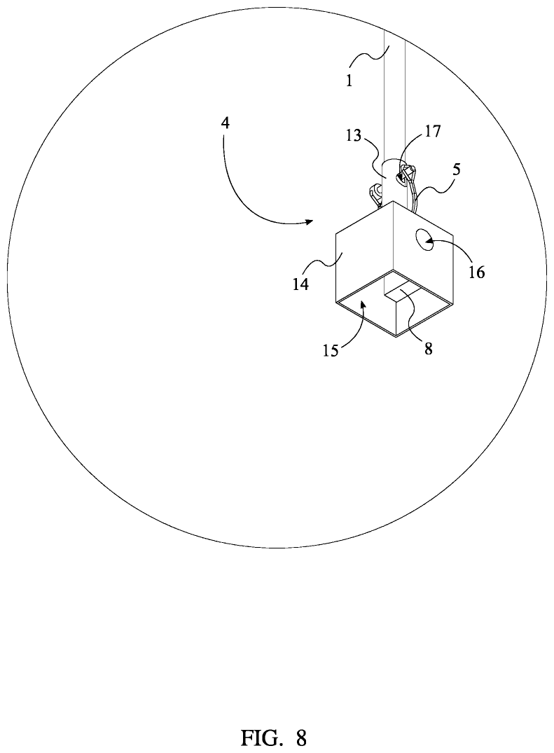

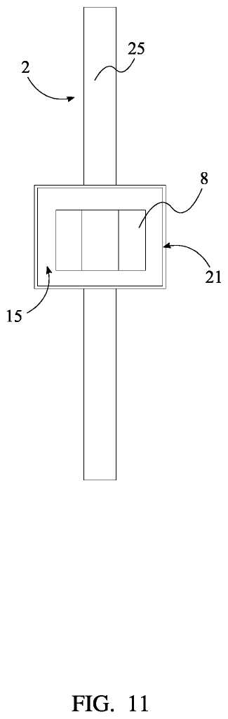

According to the preferred embodiment, the second key 4 is slidable across the rod 1 and the fastener 5 enables to securely hold the second key 4 to the rod 1 at multiple locations, depending on the operational mode of the second key 4. To that end, as seen in FIG. 7 through FIG. 11, wherein the second key 4 is in a deployed configuration, a distal end hole 23 from the first plurality of fastening holes 12 is positioned adjacent the second end 6 of the rod 1 and the fastener 5 is engaged between the distal end hole 23 and the second plurality of fastening holes 17. This arrangement securely fastens the second key 4 adjacent the terminal end of the rod 1 and makes the second key 4 operable for various functions. Further, as seen in FIG. 7, FIG. 8 and FIG. 11, during the deployed configuration, the first key 3 is positioned within the inner compartment 15. This is so that the first key 3 is in a hidden position within the second key 4 and the first key 3 does not hinder the smooth operation of the second key 4.

Alternately, as seen in FIG. 1 through FIG. 6, wherein the second key 4 is in a stored configuration, a proximal end hole 24 from the first plurality of fastening holes 12 is positioned adjacent the first end 6, and the fastener 5 is engaged between the proximal end hole 24 and the second plurality of fastening holes 17. This arrangement enables the second key 4 to be held away from the first key 3 such that the second key 4 does not hinder the smooth functioning of the first key 3. As seen in FIG. 2 and FIG. 8, the receptacle 14 comprises a square cross section and the sleeve 13 comprises a circular cross section.

It is an aim of the present invention to provide enough leverage while operating the multi-functional water meter key. In order to accomplish that the handle 2 comprises a handle rod 25, wherein the handle rod 25 is tangentially mounted onto the first end 6. Further, as seen in FIG. 4, the first end 6 is connected halfway along a length 26 of the handle rod 25. Furthermore, the handle rod 25 and the rod 1 are cylindrical and hollow. However, the handle rod 25 and the rod 1 may comprise any other shape, size, orientation etc. that are known to one of ordinary skill in the art, as long as the objectives of the present invention are not altered.

Although the invention has been explained in relation to its preferred embodiment, it is to be understood that many other possible modifications and variations can be made without departing from the spirit and scope of the invention as hereinafter claimed.

What is claimed is:

1. A multifunctional water meter key, comprising:
a rod;
a handle;
a first key;
a second key;
a fastener;
the rod comprising a first end and a second end;
the first end being positioned opposite to the second end across the rod;
the handle being terminally mounted onto the first end;
the first key being terminally mounted onto the second end;
the second key being slidably coupled along the rod; and
the fastener being removably engaged between the rod and the second key.

2. The multifunctional water meter key of claim 1, comprising:
wherein the second key is in a deployed configuration:
the second key being positioned adjacent the second end;
the second key being fastened to the rod by the fastener; and
the first key being encompassed by the second key.

3. The multifunctional water meter key of claim 1, comprising:
wherein the second key is in a stored configuration:
the second key being positioned adjacent the first end; and
the second key being fastened to the rod by the fastener.

4. The multifunctional water meter key of claim 1, comprising:
the first key comprising a cuboid body, a slot, a first surface and a second surface;
the slot laterally traversing through the cuboid body;
the first surface being positioned opposite to the second surface across the cuboid body;
the first surface being attached to the second end of the rod;
the slot being positioned centrally along the cuboid body; and
the slot traversing from the second surface towards the first surface.

5. The multifunctional water meter key of claim 4, wherein the slot comprises a rectangular cross section.

6. The multifunctional water meter key of claim 1, comprising:
a first plurality of fastening holes;
the first plurality of fastening holes laterally traversing the rod; and
the first plurality of fastening holes being distributed along the rod.

7. The multifunctional water meter key of claim 6, comprising:
the second key comprising a sleeve, a receptacle, an inner compartment, a plurality of mud holes, and a second plurality of fastener holes;
the sleeve comprising a third end and a fourth end, wherein the third end is positioned opposite to the fourth end across the sleeve;
the receptacle comprising a fifth end and a sixth end, wherein the fifth end is positioned opposite to the sixth end across the sleeve;
the third end being positioned facing the handle and the fourth end being positioned facing the second end of the rod;
the sleeve being wrapped around the rod;
the fifth end of the receptacle being attached to the fourth end of the sleeve;
the inner compartment traversing into the receptacle from the sixth end towards the fifth end;
the plurality of mud holes laterally traversing through the receptacle; and
the second plurality of fastener holes laterally traversing through the sleeve.

8. The multifunctional water meter key of claim 6, comprising:
wherein the second key is in a deployed configuration:
a distal end hole from the first plurality of fastening holes being positioned adjacent the second end;
the first key being positioned within the inner compartment;
the fastener being engaged between the distal end hole and the second plurality of fastening holes.

9. The multifunctional water meter key of claim 6, comprising:
wherein the second key is in a stored configuration:
a proximal end hole from the first plurality of fastening holes being positioned adjacent the first end;
the fastener being engaged between the proximal end hole and the second plurality of fastening holes.

10. The multifunctional water meter key of claim 6, wherein the receptacle comprises a square cross section and the sleeve comprises a circular cross section.

11. The multifunctional water meter key of claim 6, wherein the first plurality of holes being circular in shape.

12. The multifunctional water meter key of claim 6, wherein a transversal cross section of the inner compartment enables the second key to be operably coupled to a plurality of plugs.

13. The multifunctional water meter key of claim 1, comprising:
the handle comprising a handle rod;
the handle rod being tangentially mounted onto the first end; and
the first end being connected halfway along a length of the handle rod.

14. The multifunctional water meter key of claim 1, wherein the handle rod and the rod are cylindrical and hollow.

15. A multifunctional water meter key, comprising:
a rod;
a handle;
a first key;
a second key;
a first plurality of fastening holes;
a fastener;
the rod comprising a first end and a second end;
the first end being positioned opposite to the second end across the rod;
the handle being terminally mounted onto the first end;
the first key being terminally mounted onto the second end;
the second key being slidably coupled along the rod; and
the first plurality of fastening holes laterally traversing the rod;
the first plurality of fastening holes being distributed along the rod; and
the fastener being removably engaged between the rod and the second key through the first plurality of fastening holes.

16. The multifunctional water meter key of claim 15, comprising:
the first key comprising a cuboid body, a slot, a first surface and a second surface;
the slot laterally traversing through the cuboid body;
the first surface being positioned opposite to the second surface across the cuboid body;
the first surface being attached to the second end of the rod;
the slot being positioned centrally along the cuboid body; and
the slot traversing from the second surface towards the first surface.

17. The multifunctional water meter key of claim 15, comprising:
the second key comprising a sleeve, a receptacle, an inner compartment, a plurality of mud holes, and a second plurality of fastener holes;
the sleeve comprising a third end and a fourth end, wherein the third end is positioned opposite to the fourth end across the sleeve;
the receptacle comprising a fifth end and a sixth end, wherein the fifth end is positioned opposite to the sixth end across the sleeve;
the third end being positioned facing the handle and the fourth end being positioned facing the second end of the rod;
the sleeve being wrapped around the rod;
the fifth end of the receptacle being attached to the fourth end of the sleeve;
the inner compartment traversing into the receptacle from the sixth end towards the fifth end;
the plurality of mud holes laterally traversing through the receptacle; and
the second plurality of fastener holes laterally traversing through the sleeve.

18. The multifunctional water meter key of claim 15, comprising:
wherein the second key is in a deployed configuration:
the second key being positioned adjacent the second end;
the second key being fastened to the rod by the fastener; and
the first key being encompassed by the second key.

19. The multifunctional water meter key of claim 15, comprising:
wherein the second key is in a stored configuration:
the second key being positioned adjacent the first end; and
the second key being fastened to the rod by the fastener.

20. The multifunctional water meter key of claim 15, wherein the receptacle comprises a square cross section and the sleeve comprises a circular cross section.
